(19) United States
(12) Patent Application Publication
(10) Pub. No.: US 2007/0206622 A1
(43) Pub. Date: Sep. 6, 2007

(54) Method of transmitting audiovisual streams ahead of the user commands, and receiver and transmitter for implementing the method

(75) Inventors: Remi Houdaille, (US); Willem Lubbers, (US); Eric Gautier, (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing

(21) Appl. No.: 11/709,010

(22) Filed: Feb. 20, 2007

(30) Foreign Application Priority Data
Mar. 3, 2006 (FR) 0650759

(51) Int. Cl. H04L 12/28

(52) U.S. Cl. 370/431

(57) ABSTRACT

The present invention relates to a method of transmitting audiovisual streams between at least one device controlled by a user and a server. The audiovisual streams specified by the requests from the user are displayed on the device. The user enters a first command to change stream to the server in order to set up a communication for the transmission of the determined stream. The server then creates the determined stream and at least one second stream with a reduced bandwidth. This second stream corresponds to a stream that is immediately accessible by a second command from the user.

The invention also relates to a receiver and a transmitter for implementing the method.

### FIELD OF THE INVENTION

The invention relates to a method of transmitting audiovisual streams between a device controlled by a user and a server, a multimedia receiver provided with a user interface for implementing the method and a transmitter transmitting the audiovisual streams.

### BACKGROUND

In a digital television system, the number of channels available becomes very large. Several hundred channels can be made available to the user. The users can select a channel using an electronic program guide (EPG), or even switch from one channel to another by pressing the “Program+” or “Program−” buttons on the remote control associated with their receiver, navigating in a way that is commonly called “zapping”. In the first case, the EPG can be made up of a mosaic of images showing the video of the programs transmitted on a certain number of channels, typically 16 channels. These images are small, so the audiovisual data to display each of them does not need any great precision, and because of this the streams that transmit the videos can be in low resolution mode. A low-resolution stream, or reduced stream, is a stream having a bandwidth that is very much lower than a normal stream. In the zapping case, the receiver has an ordered list of channels. Normally, the transmission network assigns the channels a number, and the order followed by the navigation program when the user hops to the next channel or the preceding channel. The user can also create a favourites list by selecting certain channels from those offered by the network, and the user then navigates within his list by zapping from one channel to another.

The user's device is also provided with a unit for receiving data streams D from a communication network. The communication is conducted either in “multicast” mode (literally “point-to-multipoint” mode), or in “unicast” mode (literally “point-to-point” mode). In the latter case, the device has a bidirectional communication means, preferably high speed, for example an IP DSL line (DSL standing for “Digital Subscriber Line”) to receive the audiovisual data packets. The device addresses a request to a server of the network to receive a determined channel, in the case of a multicast, a router receives the various requests and processes them.

When zapping, the images of the programs transmitted by the device appear in succession on the screen. In all cases, the switchover times depend in particular on:

transmission times for commands between the client and the network router,

times for setting up the streams,

the size of the IP packet management buffers, to take up the variations in the arrival of the latter,

the size of the video processing buffers,

the resynchronization of the decoding requiring a wait for the next intra-coded image.

Because of this, when changing channels, the image on the screen is frozen, and sometimes a black screen appears. One solution would involve transmitting all the channels, the device performing only a simple switchover without transmitting any request to the server. However, on an ADSL type access, the available bandwidth does not allow for the permanent transit of multiple audiovisual streams in parallel, and nor do the decoding resources on the receiving device normally allow for decoding operations to be multiplied in parallel. This solution is therefore not satisfactory.

The document WO 2005/112465 filed by THOMSON and describes a method for reducing the bit rate of the “normal” stream. Following a request to change channel, the decoder asks a server to receive the new channel in full-definition mode and this same channel in low-resolution mode. The normal streams and those reserved for zapping are multiplexed in one and the same channel. The low-resolution channel is almost immediately transmissible and therefore the zapping time is reduced, but not to zero. In practice, the image of the desired channel appears after the decoder transmits the request to the server and the server sends it the degraded stream.

The document US 2006/020995 filed by OPIE describes a server transmitting streams to a plurality of decoders. A user commands the switch from one channel to another on his decoder. The server sends on demand at least one image I in the unicast stream. The encoder on the transmission server generates a conventional audio/video stream CONVID. Another stream (FILLVID) is generated to replace the black image with a true image. The FILLVID image stream makes it possible to switch over more quickly when zapping. However, these streams are constantly transmitted which occupies a bandwidth unnecessarily if the user does not select these channels.

The present invention provides a novel solution to this problem of reducing the channel switchover time when zapping while optimizing the bandwidth used.

### SUMMARY OF THE INVENTION

The subject of the invention is a method of transmitting audiovisual streams from a server to a device, comprising a step for entering a command in order to view a first audiovisual data channel on the device and a step for transmitting to the device a first stream in full-definition mode corresponding to this first channel in response to the entry of the first command;

wherein it comprises a second step for transmitting from the server to the device at least one second stream also in response to the entry of the command, this second stream having a smaller bandwidth than the first and transmitting the audiovisual data of a second channel, this second channel being able to be received by a stream in full-definition mode by entering a second command following the first command.

In this way, the invention makes it possible to exploit the availability of a low-resolution stream on the channel to which the user can imminently select using a command. The device receiving the low-resolution stream can thus anticipate an imminent command to change channel.

According to an improvement, the method comprises a step for entering the second command triggering a first step for displaying the second channel received by the second stream having a reduced bandwidth and a step for transmitting to the device a third stream in full-definition mode corresponding to this second channel, the reception of the third stream triggering the display of the second channel in full-definition mode. In this way, the user immediately sees the image extracted from the low-resolution stream when he requests a change of channel. Then, when the full-definition stream is correctly received, the display switches over to the full-definition stream.

According to another improvement, the first display step comprises a step for animating the image extracted from the channel with a reduced bandwidth. In this way, the transition between the low-resolution stream and the full-definition stream is less surprising to the user. According to an improvement, the animation step ends with the display of the images transmitted by the full-definition stream, which further reduces the perception of the transition.

According to another improvement, the device can display a mosaic image made up of the images transmitted by all the channels transmitted by the server, whether in full-definition mode or with a reduced bandwidth. The user can thus have a multiple choice of zapping commands, and each time by entering a command, he can immediately see an image of the newly selected channel.

According to an improvement, the channel with a reduced bandwidth is extracted from a channel transmitting a mosaic image. In this way, the invention uses an existing mosaic stream to extract therefrom the streams with a reduced bandwidth. According to an improvement, the device can create a favourites list of channels, the other channel being immediately accessible by the second user command by navigating in said favourites list. Thus, each device is customized and the server contributes to the anticipation of the channel change commands. According to an improvement, the device displays a channel in full-definition mode and identifiers identifying the second streams.

Another subject of the invention is a transmitter comprising a means of transmitting audiovisual streams over a network, and a means of receiving a request originating from a device for the transmission of a determined stream triggering the activation of the transmission means to transmit the determined stream in full-definition mode to the device. The transmitter comprises a means of transmitting to the same device at least one second stream with a reduced bandwidth, said transmission means also being activated by the means of receiving the request, the second stream being accessible by a command entered on the device when the determined stream is being viewed.

Another subject of the invention is a receiver comprising a means of receiving audiovisual streams transmitted by a network, a means of displaying a received stream and a means of transmitting a request for the transmission of a stream in full-definition mode selected by the user. The receiver also comprises a means of receiving at least one second stream with a reduced bandwidth, a means of entering a command to change stream triggering the transmission of a request for the transmission of the new stream and the display of the content of the second stream received with a reduced bandwidth, the new stream then being displayed when the reception in full-definition mode is established.

### BRIEF DESCRIPTION OF THE DRAWINGS

The present invention will now become apparent with more details in the context of the description that follows of exemplary embodiments given by way of illustration, by referring to the appended figures, among which:

FIG. 1 is a block diagram of an audiovisual receiver for implementing the invention,

FIG. 2 is a diagram showing the various elements of a server according to the invention,

FIGS. 3.a, 3.b, 3.c and 3.d illustrate the various dialogue steps between the audiovisual receiver and the server;

FIGS. 4.a, 4.b and 4.c represent screen appearances for implementing the invention.

### DETAILED DESCRIPTION

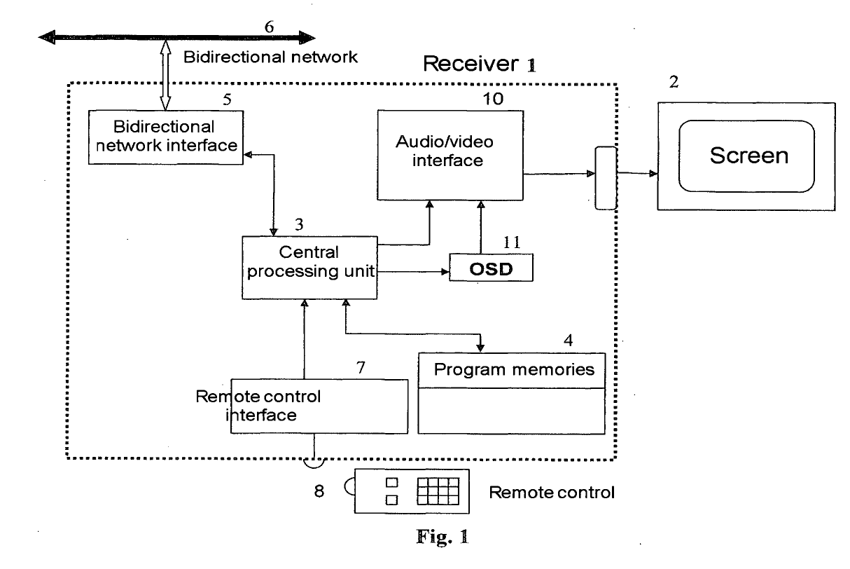

The operation of an audiovisual receiver 1 connected to a display device 2 will be described first using FIG. 1. The receiver comprises a central processing unit 3 linked to a program memory (ROM) and working memory (RAM) 4, and an interface 5 for a bidirectional communication with a network 6. According to a particular embodiment, the device is a computer provided with a graphic screen. The network is typically the Internet but the present invention relates to any network enabling audiovisual streams to be received, the bit rate must be sufficient but relatively limited for the possibility of transmitting all the streams in full-definition mode not to be possible. According to a preferred exemplary embodiment, the network uses ADSL technology. The receiver further comprises a receiver of infrared signals 7 to receive the signals from a remote control 8 and an audio/video decoding logic 10 for generating the audiovisual signals sent to the television screen 2. The remote control 8 is provided with direction buttons ↑, ↓, →, ← and buttons: P+, P− and OK, the use of which will be explained later in the description. The receiver also comprises a circuit 11 for displaying data on the screen often called OSD (On-Screen Display) circuit. The OSD circuit 11 is a generator of text and graphics which makes it possible to display menus or pictograms (for example, a number corresponding to the channel being viewed) on the screen, or which makes it possible to mix two audiovisual contents. The OSD circuit is controlled by the central processing unit 3 and a program called “zapper” which is resident in the memory 4. The zapper is typically made up of a program module entered into read-only memory and parameters stored in random-access memory. The zapper can also be implemented in the form of a custom circuit, of ASIC type for example. This circuit can be provided with security functions making it possible to make a payment when a user decides to view a transmission that is subject to payment.

The receiver receives audiovisual transmission identification data from the return channel 6 or from the transmission network. This data comprises items that can be viewed, the title for example, or an image of the trailer. Using an EPG and the buttons of his remote control, the user selects one or more transmissions in order to receive them.

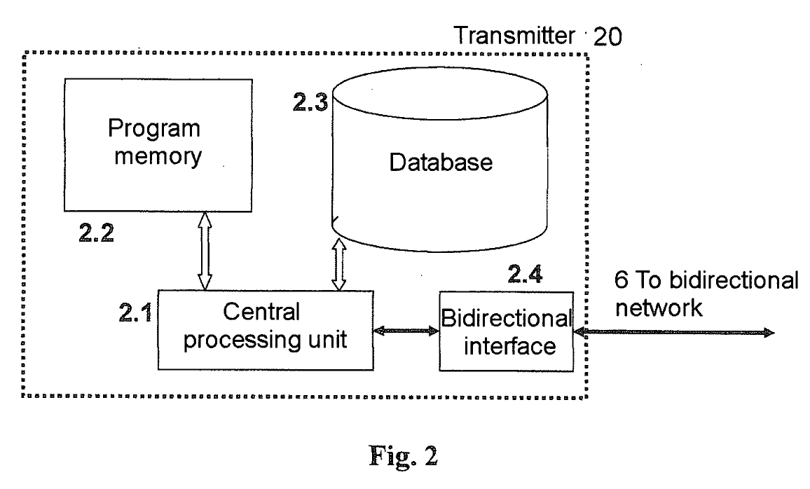

The transmitter transmitting the streams is, according to a preferred embodiment, a DSLAM server 20 which is described in FIG. 2 comprises a central processing unit 2.1, a program memory 2.2, an encoding logic 2.3 and a communication interface setting up a plurality of bidirectional links 2.4 across the network 6 with the receivers described previously. The DSLAM server 20 receives from a transmitter all the channels of the bouquet of programs. At the request of a user, the DSLAM transmits to its receiver the desired program in a standard definition or SD stream. The network termination produces a low-resolution stream and transmits it to the encoding logic 2.3 of the DSLAM. This reduced stream can be used in particular for a program guide. The current trend is to provide, in the user interaction, a thumbnail display of the program that is presented (in the case of the zapping panel, this is in parallel with the display of the full-screen video).

The transmission of a reduced-size stream (typically 1/16th image, also called QCIF) can be taken up in addition to a stream in the bandwidth. The real time decoding of a full-definition stream in parallel with a reduced stream is acceptable.

After having described the various elements of the invention, we will now go on to explain how they cooperate.

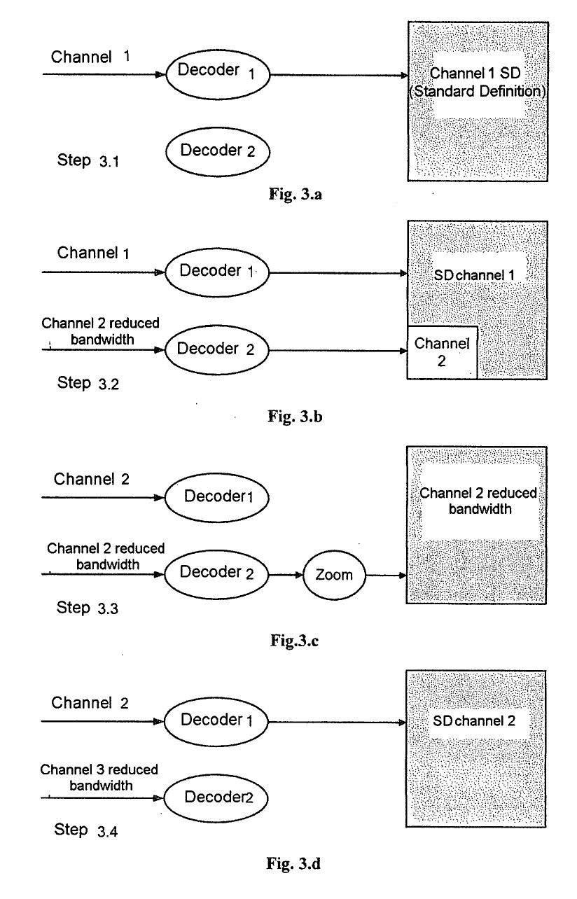

The various dialogues between the user and the server are illustrated by the various steps illustrated by the four FIGS. 3.a, 3.b, 3.c and 3.d.

In the step 3.1 illustrated by FIG. 3.a, the user has entered a channel number on his remote control, the request has been transmitted to the DSLAM 20. Then, the communication is set up and the audiovisual content of the selected channel is transmitted. In the step 3.2 illustrated in FIG. 3.b, the receiver 1 starts running the zapper as a background task. The zapper identifies the channel 1 being received and deduces from it the programs that are immediately accessible if the user presses the P+ or P− button of his remote control 8. Typically, the zapping order is defined by the program transmitter by the numbers of the streams, so it is possible to expect that the next zapping command will select the channel 2. In this way, the server, on receiving the channel change request, deduces which reduced stream channel it has to transmit. A variant consists in the user defining a favourites list and navigating within this list using the P+, P− buttons on the remote control 8. The zapper transmits to the DSLAM 20 a request to set up the requested full-definition stream and the reduced streams of the programs following and/or preceding the one requested. The receiver 1 then receives the full-definition stream F1 of the channel selected by the user and at least the reduced stream F′2 (possibly F′3, F′4, etc.). The display is in real time, immediately the synchronization of the data is completed.

In the step 3.3 illustrated by FIG. 3.c, the user presses the P+ button on his remote control 8. The zapper transmits a request to the DSLAM to receive the channel F2 which follows the channel F1 currently being transmitted. At the same time, the zapper switches the extraction of the data to be displayed from the stream F1 to the reduced stream F′2, the data is sent to the audio/video decoding logic 10 for video playback on the display means 2 and the transmission of audio signals. In this way, the zapping command immediately results in the appearance of the desired program. Inasmuch as the zapper uses a reduced stream, the playback will be of mediocre quality but sufficient for the user to follow the action. If the reduced stream is designed to display a small animated image (or “imagette”) for it to be incorporated in a mosaic image for example, the zapper enlarges the small animated image and displays it full screen. When the stream F2 arrives at an image that makes it possible to tune into it, the display switches from the reduced stream to the full-definition stream.

In the step 3.4 illustrated by FIG. 3.d, the DSLAM transmits the desired program via a full-definition stream F2. The receiver extracts the data from the full-definition stream and sends it to the audio/video decoding logic 10 for video playback on the display means 2 and the transmission of audio signals. From this moment, the user receives the desired channel with an optimal playback quality. The DVB_IP standard recommends the use of RTP and RTSP signals to manage the synchronization between multiple streams. The receiver 1 uses these signals to ensure the synchronization on transitions between a reduced stream F′i and the corresponding full-definition stream Fi, and vice versa. Then, the zapper transmits to the DSLAM a request to set up the reduced streams of the new programs that have the greatest probability of being selected by the user by entering zapping commands using the P+ or P− buttons on the remote control 8.

It will be noted that the receiver requests streams that the user does not request, in order to adopt a position such that, if the user changes channel, the corresponding reduced stream is already connected. Various known anticipation heuristics may be usable here.

According to an improvement, just after a new channel has been selected by a zapping command, the references of the following and preceding streams that are identified by the zapper appear in a panel at the bottom of the screen. This panel disappears after a few seconds. In this way, the user knows that these channels can immediately be viewed by a zapping command.

In the above text, the invention is described in the context of zapping, when the user is navigating from channel to channel by entering a command. The invention is not limited to this context, other events can trigger requests that anticipate the behaviour of the user. For example, when the program currently being transmitted mentions other programs transmitted on other channels at the same time, the receiver 1 asks the DSLAM to transmit to it the reduced streams of channels transmitting these programs in case the user might select one. Another event is the user taking hold of the remote control, handling sensors on the remote control 8 informing the receiver that the user has taken the remote control probably in order to enter a new command. The receiver 1 anticipates the zapping command by asking the DSLAM to transmit to it the streams of the programs following and preceding the current one in the zapping list.

According to a simple embodiment, the zapper requests only one reduced stream. This stream is the one corresponding to the channel selected by the user by the same last zapping command. If, to access the current program, the user has pressed P+, then it is the reduced stream of the following channel that is requested of the DSLAM. If, to access the current program, the user has pressed P−, then it is the reduced stream of the preceding channel that is requested of the DSLAM. In a more bandwidth-intensive mode, the zapper asks the server for two reduced streams corresponding to the two channels that can be accessed either by the P+ command or by the P− command.

According to another embodiment, the server transmits a stream transporting a mosaic image made up by aggregating reduced streams on the server. The receiver extracts from the mosaic image the image of the channel requested by the zapping command, this image is enlarged and appears full screen following the zapping command. The advantage of this embodiment is that the server constantly transmits the mosaic streams, so there is no need for any specific request to the server. According to a variant of embodiment, the server does not transmit mosaic streams, so that it is the zapper which asks to receive eight reduced streams, four streams corresponding to the channels that can be accessed by pressing the “P+” button once, twice, three times and four times, and four streams corresponding to the channels that can be accessed by pressing the “P−” button once, twice, three times and four times. By pressing the “M” (for “mosaic”) button, the zapper shows the videos transmitted by the eight reduced streams and the stream received in full-definition mode, preferably the video image of the stream received in full-definition mode being in the middle of the mosaic of nine images. In this way, the mosaic image appears in a very short time since the streams are already available. The mosaic image can comprise a number of images other than nine, for example 16 or 25. In the mosaic mode, by pressing “P+” or “P−”, the user changes the channel received in full-definition mode. The device sends a request to the server asking to receive a new channel in reduced mode. Initially, the mosaic displays eight images, then the ninth corresponding to the new reduced stream channel. This delayed appearance enables the user to better distinguish the changes from one mosaic image to another, and in particular the image of the new channel.

A reduced stream is a stream used to display an image of lower definition than a normal image. The reduced stream can have a short GOP form which favours faster zapping than the full-definition sequence (the overhead of the images I on this image size is less than in full-definition mode).

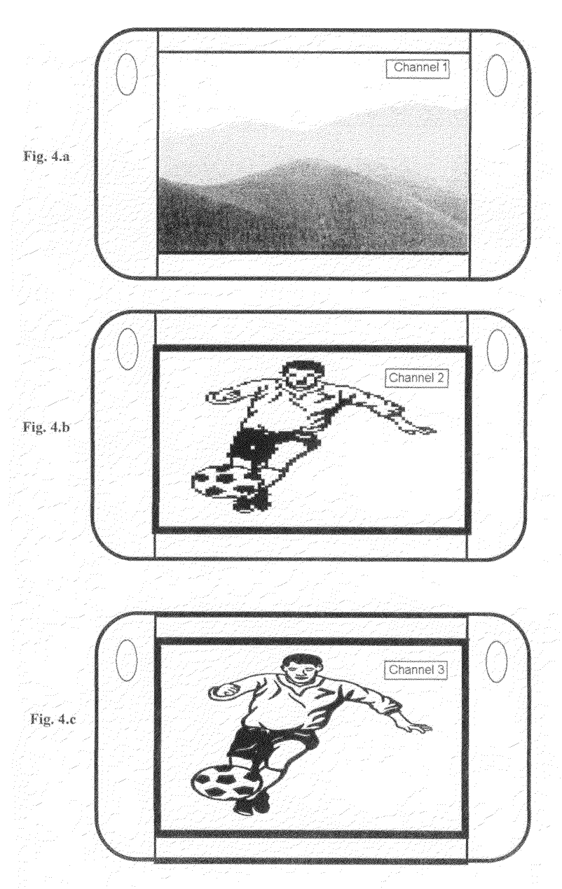

FIGS. 4.a, 4.b and 4.c show the changes to the images displayed before and after a zapping command. FIG. 4.a shows the image extracted from a full-definition stream. The user activates a command to switch to the next channel. The zapper extracts the image from the reduced stream and the screen appearance of FIG. 4.b then appears. The image displayed is of mediocre quality. After a certain time, the receiver sets up the full-definition stream and displays the image represented in FIG. 4.c, which is of optimal quality.

As can be seen in FIG. 4, just after the zapping command, the image taken from the reduced stream is degraded relative to the image in full-definition mode. Improvements make it possible to temporarily mask this degradation to the eyes of the user. In practice, the visual transition between the reduced stream and the full-definition stream is relatively marked, which can surprise the user. A first approach consists in displaying the degraded image, by giving it a “zoom effect” to progressively expand the starting small animated image to cover all the screen area. Such an animation takes a time that can be the same as the time needed to tune into the full-definition stream. Visually, in an image with varying size, the resolution problems are less noticeable. Since the image is small at the outset, the fact that it is extracted from a reduced stream is thus largely masked. Another approach consists in creating an animation, the image extracted from the reduced stream appears as a screen portion, sometimes on the left, sometimes on the right. Another approach consists in presenting the image extracted from the reduced stream on two sides of a rotating and enlarging cube. At the end of the rotation, the side occupies the entire screen and it is at this moment that the switchover to the full-definition stream occurs. Another approach consists in creating a fade-in, fade-out or any other animation, the aim of which is to divert the attention of the user from the quality of the initial images. In all cases, the animation lasts for the time it takes to set up the full-definition stream. When the full-definition stream is set up, the full-definition image extracted from this stream is displayed. Advantageously, this time corresponds to the longest time measured on a previous switchover.

Another way of masking the transition from the eyes of the users consists in fitting a filter. Typically, the receiver calculates a weighted average between the enlarged image taken from the reduced stream and the full-definition image. The weighting varies from (100%, 0%) to (0%, 100%) in a time that comprises at least the time needed to set up the full-definition stream. Advantageously, the time of the filtering step significantly exceeds that of setting up the stream, which makes it possible ultimately to use the full-definition data and so achieve a 100% full-definition image.

1. Method of transmitting audiovisual streams from a server to a device, comprising a step for entering a first command in order to view a first audiovisual data channel on the device and a step for transmitting to the device a first stream in full-definition mode corresponding to this first channel in response to the entry of the first command;
wherein it comprises a second step for transmitting from the server to the device at least one second stream also in response to the entry of the first command, this second stream having a smaller bandwidth than the first and transmitting the audiovisual data of a second-channel, this second channel being able to be received by a stream in full-definition mode by entering a second command following the first command.

2. Method of transmitting audiovisual streams according to claim 1;
wherein it comprises a step for storing a list of audiovisual channels, a second stream to be transmitted with a reduced bandwidth being one of the elements following or preceding the first stream within said list.

3. Method of transmitting audiovisual streams according to claim 1;
wherein it comprises a step for entering the second command triggering a first step for displaying the second channel received by the second stream having a reduced bandwidth and a step for transmitting to the device a third stream in full-definition mode corresponding to this second channel, the reception of the third stream triggering the display of the second channel in full-definition mode.

4. Method of transmitting audiovisual streams according to claim 3;
wherein the first display step comprises a step for animating the image transmitted by the stream having a reduced bandwidth.

5. Method of transmitting audiovisual streams according to claim 4;
wherein the animation step ends with the display of the images in full-definition mode transmitted by the third stream.

6. Method of transmitting audiovisual streams according to claim 1;
wherein the second transmission step consists in transmitting a plurality of second streams accessible by second user commands, and a step for displaying on the device a mosaic image displaying the visual contents extracted from said second streams.

7. Method of transmitting audiovisual streams according to claim 1;
wherein the stream with a reduced bandwidth is extracted from a stream transmitting a mosaic image.

8. Method of transmitting audiovisual streams according to claim 1;
wherein it comprises a step for creating a second stream favourites list, one of the second streams being immediately accessible by the second user command by navigating in said favourites list.

9. Method of transmitting audiovisual streams according to claim 1;
wherein it comprises on the device a step for displaying the first channel in full-definition mode and identifiers identifying the second streams.

10. Transmitter comprising a means of transmitting audiovisual streams over a network, and a means of receiving a request originating from a device in order to view a first audiovisual data channel on said device following the entry of a first command on the device triggering the activation of the transmission means to transmit a first stream in full-definition mode to the device;
wherein it comprises a means of transmitting to the same device at least one second stream with a reduced bandwidth, said transmission means also being activated by the means of receiving the request, each second stream transmitting the audiovisual data of second channels, each second channel being able to be received by a stream in full-definition mode by the entry of a second command following the first command.

11. Transmitter of audiovisual streams according to claim 10; wherein it comprises a means of storing a list of audiovisual channels, a second stream to be transmitted with a reduced bandwidth being one of the elements following or preceding the first stream within said list.

12. Receiver comprising a means of receiving audiovisual streams transmitted by a network, a means of displaying a received stream, a means of entering a first command in order to display a first audiovisual data channel and a means of transmitting a request for the transmission of a first stream in full-definition mode corresponding to this first channel in response to the entry of the first command;
wherein it comprises a means of receiving at least one second stream with a reduced bandwidth, this second stream having a bandwidth that is smaller than the first and transmitting the audiovisual data of a second channel, this second channel being able to be received by a stream in full-definition mode by the entry of a second command following the first command.

13. Receiver of audiovisual streams according to claim 12; wherein it comprises a means of storing a list of audiovisual channels, the transmission means transmits a request for the transmission of at least one second stream with a reduced bandwidth, a second stream to be transmitted with a reduced bandwidth being one of the elements following or preceding the first stream within said stored list.

14. Receiver of audiovisual streams according to claim 13; wherein it comprises a means of entering the list of audiovisual channels.

15. Receiver of audiovisual streams according to claim 12; wherein the display means displays the second reduced bandwidth stream in the form of an animation.

16. Receiver of audiovisual streams according to claim 12; wherein the reception means receives a plurality of second reduced bandwidth streams, the receiver comprising a means of creating a mosaic image displaying the visual contents extracted from said second streams.

17. Receiver of audiovisual streams according to claims 12; wherein the reception means receives a stream transmitting mosaic images, the second streams being extracted from the parts of the mosaic image corresponding to the second audiovisual data channels.

18. Receiver of audiovisual streams according to claims 12; wherein the display means displays the channel in full-definition mode and identifiers identifying the second streams.
